(19) United States
(12) Patent Application Publication
(10) Pub. No.: US 2014/0143871 A1
(43) Pub. Date: May 22, 2014

(54) METHOD OF INSPECTING MASS WEBSITES BY VISITING

(71) Applicant: KOREA INTERNET & SECURITY AGENCY, Seoul (KR)

(72) Inventors: Tai Jin LEE, Seoul (KR); Byung Ik KIM, Seoul (KR); Hong Koo KANG, Seoul (KR); Chang Yong LEE, Seoul (KR); Ji Sang KIM, Seoul (KR); Hyun Cheol JEONG, Seoul (KR)

(73) Assignee: KOREA INTERNET & SECURITY AGENCY, Seoul (KR)

(21) Appl. No.: 14/065,722

(22) Filed: Oct. 29, 2013

(30) Foreign Application Priority Data
Nov. 19, 2012 (KR) 10-2012-0130960

(51) Int. Cl. H04L 29/06

(52) U.S. Cl. CPC H04L 63/1441
USPC 726/23

(57) ABSTRACT

Disclosed is a method of inspecting mass websites by visiting, which inspects the mass websites by visiting at a high speed using multiple browsers and multiple frames. The method of inspecting mass websites includes the steps of: simultaneously visiting, if a list of inspection target websites is received, a plurality of inspection target websites using multiple browsers; inspecting whether or not a malicious code infection attack is generated at the plurality of inspection target websites visited through the multiple browsers; and tracing, if the malicious code infection attack is detected among the plurality of inspection target websites, a malicious website through revisit inspection using a tree search algorithm.

### BACKGROUND OF THE INVENTION

1. Field of the Invention

The present invention relates to a method of inspecting mass websites by visiting, which inspects the mass websites by visiting at a high speed using multiple browsers and multiple frames.

2. Background of the Related Art

Although a web gives us great convenience and almost all the people in the world use the web every day, it is frequently but maliciously used as a medium for spreading a malicious code without the knowledge of a user. When a website frequently visited by users is maliciously used for distributing a malicious code, it needs to pay special attention since damage of the users can be expanded greatly. Expansion of the damage incurred by the malicious code can be minimized through preemptive detection and measurement.

Since unknown attacking techniques such as malicious use of vulnerability, application of detection avoidance techniques and the like are evolved recently, detection techniques need to be enhanced. Typical methods of inspecting a website hiding a malicious code includes a low interaction web crawling detection method which is speedy but signature-dependent and a high interaction behavior-based detection method having a wide detection range and capable of detecting an unknown attack with a low speed.

However, there are a large number of websites operating on the Internet, and the number of inspection target URLs will be millions, tens of millions or more considering sub-pages. In order to perform an inspection on the large number of websites through a high interaction system, the analysis environment consuming two to three minutes to inspect one website should be improved greatly to practically use the inspection method.

### SUMMARY OF THE INVENTION

Therefore, the present invention has been made in view of the above problems, and it is an object of the present invention to provide a method of inspecting mass websites by visiting, which inspects the mass websites by visiting at a high speed using multiple browsers and multiple frames.

To accomplish the above object, according to one aspect of the present invention, there is provided a method of inspecting mass websites by visiting, the method including the steps of: simultaneously visiting, if a list of inspection target websites is received, a plurality of inspection target websites using multiple browsers; inspecting whether or not a malicious code infection attack is generated at the plurality of inspection target websites visited through the multiple browsers; and tracing, if the malicious code infection attack is detected among the plurality of inspection target websites, a malicious website through revisit inspection using a tree search algorithm.

In addition, at the step of visiting a plurality of inspection target websites, only connectible inspection target websites are visited through a preliminary inspection of whether or not inspection target websites included in the list of mass inspection target websites are connectible.

In addition, the preliminary inspection is simultaneously inspecting whether or not a plurality of corresponding inspection target websites is connectible using a plurality of threads.

In addition, at the step of visiting a plurality of inspection target websites, if the plurality of inspection target websites is a main page, the visit inspection is performed using the multiple browsers.

In addition, at the step of visiting a plurality of inspection target websites, if the plurality of inspection target websites is a sub-page, the visit inspection is performed using the multiple browsers and multiple frames.

### BRIEF DESCRIPTION OF THE DRAWINGS

FIG. 1 is a flowchart illustrating a method of inspecting mass websites by visiting according to the present invention.

FIG. 2 is a view showing an example of visiting a plurality of inspection target websites using multiple browsers according to the present invention.

FIG. 3 is an exemplary view showing a procedure of tracing a malicious website using a tree search related to the present invention.

### DETAILED DESCRIPTION OF THE PREFERRED EMBODIMENT

An embodiment according to the present invention will be hereafter described in detail with reference to the accompanying drawings.

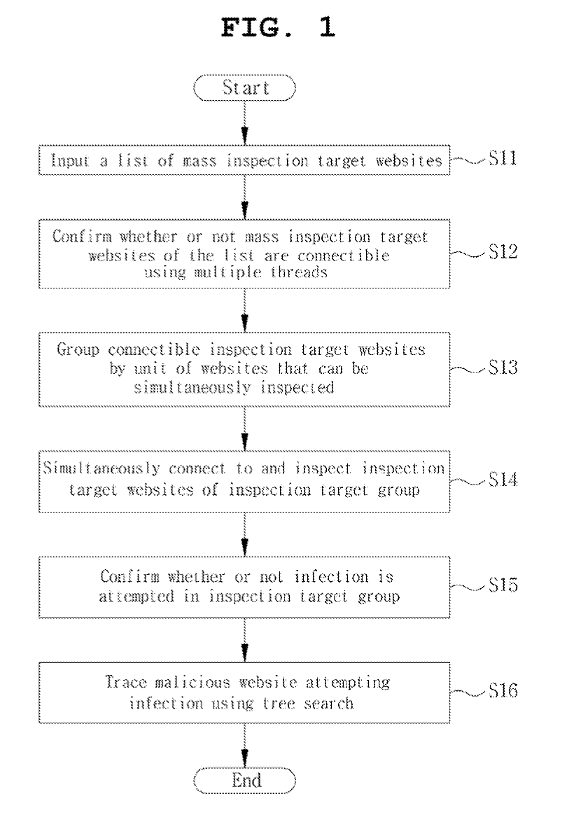

FIG. 1 is a flowchart illustrating a method of inspecting mass websites by visiting according to the present invention.

Referring to FIG. 1, an inspection server for inspecting mass websites by visiting according to the present invention receives a list of mass inspection target websites S11.

If the list of mass inspection target websites is input, the inspection server confirms in advance whether or not the inspection target websites existing in the corresponding list are connectible S12. At this point, in order to promptly confirm whether or not the inspection target websites are connectible, the inspection server confirms whether or not a plurality of inspection target websites is simultaneously connectible using multiple threads. In addition, the inspection server confirms whether or not a response is received after transmitting a domain name system (DNS) query to confirm whether or not the inspection target websites are connectible. If a DNS response is received, the inspection server transmits a synchronization signal for the TCP 80 port, and if an affirmative response signal is received, the inspection server determines that a web service is provided through the TCP 80 port.

The inspection server groups inspection target websites confirmed to be connectible among the inspection target websites included in the list of mass inspection target websites by the unit of websites that can be simultaneously inspected S13.

The inspection server executes multiple browsers, simultaneously connects to the inspection target websites of an inspection target group through the multiple browsers, and inspects whether or not a malicious code infection attack is generated S14. For example, the inspection server executes one hundred browsers and visits inspection target websites different from one another through the browsers. Then, the inspection server confirms whether or not a malicious code infection attack is generated at the currently visited one hundred inspection target websites using a technique of detecting previously known various malicious code infection attacks.

If a malicious code infection attack is generated in the inspection target group, the inspection server traces a malicious website while reducing an inspection range using a tree search (a tree algorithm) S15.

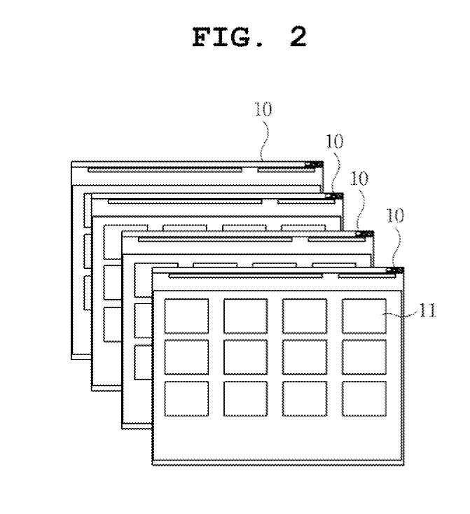

FIG. 2 is a view showing an example of visiting a plurality of inspection target websites using multiple browsers according to the present invention.

As shown in FIG. 2, the inspection server executes a plurality of browsers 10 and connects to inspection target websites through the browsers 10. At this point, if the inspection target website is a main page, the inspection server executes a predetermined number of multiple browsers 10 and simultaneously visits the inspection target websites. For example, the inspection server executes thirty multiple browsers 10 and simultaneously visits thirty different inspection target websites through the browsers.

Meanwhile, if the inspection target web page is a sub-page, the speed is amplified by simultaneously using a multi-frame visit technique. For example, if twenty browsers 10 respectively having five frames 11 are simultaneously open and the inspection target websites are visited, it is possible to inspect one hundred (5×20) websites with one inspection. In the present invention, the multi-frame is used only when a sub-page is inspected.

If an attempt of malicious code infection is not detected although a plurality of websites is simultaneously visited using the multiple browsers 10 and the multiple frames 11, the next inspection target group is visited, and if an attempt of infection is confirmed, a website having a problem (malicious website) is traced among the simultaneously visited websites. At this point, when the website having a problem is traced, the website is promptly found with a minimum number of inspections using a tree search.

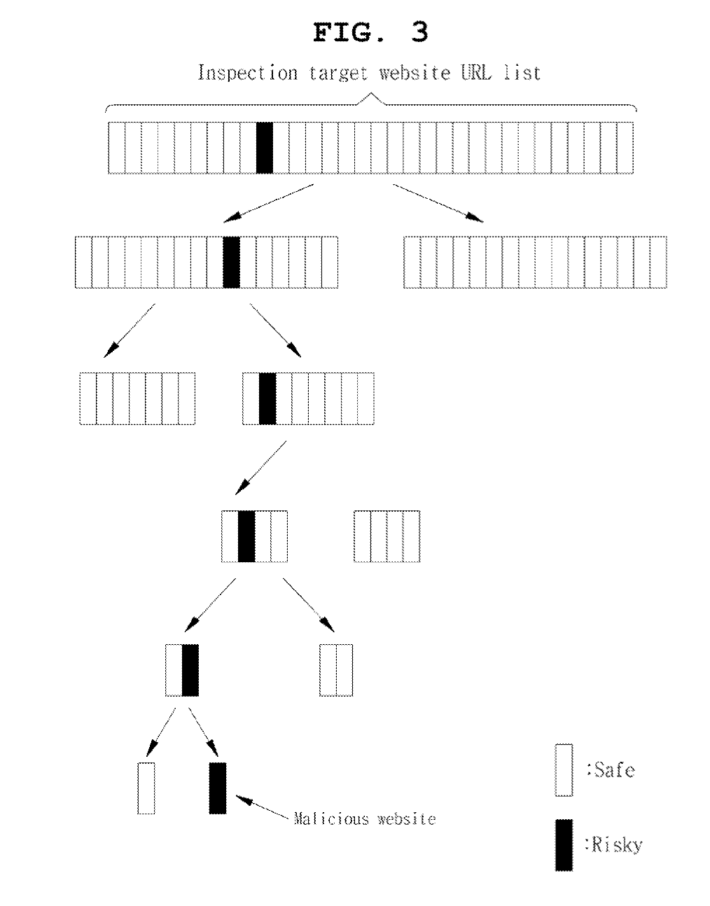

FIG. 3 is an exemplary view showing a procedure of tracing a malicious website using a tree search related to the present invention.

As shown in FIG. 3, if it is confirmed that a malicious code infection attack is generated as a result of the visit inspection performed on thirty two inspection target websites using multiple browsers, the inspection target websites are revisited and inspected by the unit of sixteen inspection target websites, which is a half of the thirty two inspection target websites. That is, sixteen browsers are executed, and sixteen inspection target websites are revisited and inspected among the thirty two inspection target websites. If it is confirmed that a malicious code infection attack is not generated as a result of the revisit inspection, the revisit inspection is performed on the other sixteen inspection target websites.

As described above, the larger the number of simultaneously visited websites is, the higher the effect of the re-inspecting method using a tree algorithm will be. For example, when a malicious website is traced among one hundred websites, the malicious website having a problem among the one hundred websites may be traced through seven inspections in the best case and fourteen inspections in the worst case, i.e., ten inspections in average.

Since the present invention performs visit inspection using multiple browsers and multiple frames, mass websites can be visited and inspected at a high speed.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of inspecting mass websites by visiting, the method comprising the steps of:
simultaneously visiting, if a list of inspection target websites is received, a plurality of inspection target websites using multiple browsers;
inspecting whether or not a malicious code infection attack is generated at the plurality of inspection target websites visited through the multiple browsers; and
tracing, if the malicious code infection attack is detected among the plurality of inspection target websites, a malicious website through revisit inspection using a tree search algorithm.

2. The method according to claim 1, wherein at the step of visiting a plurality of inspection target websites, only connectible inspection target websites are visited through a preliminary inspection of whether or not inspection target websites included in the list of mass inspection target websites are connectible.

3. The method according to claim 2, wherein the preliminary inspection is simultaneously inspecting whether or not a plurality of corresponding inspection target websites is connectible using a plurality of threads.

4. The method according to claim 1, wherein at the step of visiting a plurality of inspection target websites, if the plurality of inspection target websites is a main page, the visit inspection is performed using the multiple browsers.

5. The method according to claim 1, wherein at the step of visiting a plurality of inspection target websites, if the plurality of inspection target websites is a sub-page, the visit inspection is performed using the multiple browsers and multiple frames.
